(19) United States
(12) Patent Application Publication
(10) Pub. No.: US 2019/0297881 A1
(43) Pub. Date: Oct. 3, 2019

(54) ANTIMICROBIAL COMPOSITIONS CONTAINING ALKYL SARCOSINE AND/OR SALT THEREOF

(71) Applicant: Randall Andrew Pilon, Oakville (CA)

(72) Inventor: Faraz Ahmadpour, Mississauga (CA)

(21) Appl. No.: 16/367,577

(22) Filed: Mar. 28, 2019

Related U.S. Application Data
(60) Provisional application No. 62/649,848, filed on Mar. 29, 2018.

(51) Int. Cl. A01N 25/30; A01N 59/00; A01N 37/46

(52) U.S. Cl. CPC A01N 25/30; A01N 37/46; A01N 59/00

(57) ABSTRACT

Antimicrobial composition (e.g. ready-to-use and concentrated solutions) having a pH of from about 0 to about 4.5, and comprising a synergistic combination of at least one peroxygen compound, and at least one anionic surfactant selected from the group consisting of alkyl sarcosines and salts thereof having the formula (A):

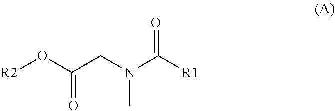

wherein R1 is a substituted or unsubstituted, saturated or unsaturated, branched or unbranched C8-24 alkyl, R2 is a hydrogen or an alkaline moiety. The solutions are free of percarboxylic acids and precursors thereof, essential oils, bleaching agents, low molecular weight organic diamines, cationic surfactants, C₁-C₄ aldehydes, ferrous salts, parabens, enzymes, and a poly(alkylene glycol) alkyl ethers containing four or more ether linkages. Dry compositions, uses and methods for sanitization, disinfection and sterilization are also disclosed.

### CROSS-REFERENCE TO RELATED APPLICATION

This application claims the benefit of U.S. provisional application 62/649,848, filed Mar. 29, 2018, the contents of which are incorporated herein by reference.

### FIELD OF THE INVENTION

The present invention relates to antimicrobial solutions and compositions for use in sanitization, disinfection and sterilization and, more particularly, solutions and compositions containing peroxygen compounds and anionic surfactants.

### BACKGROUND OF THE INVENTION

There is an ongoing effort to develop antimicrobial compositions that are effective against microorganisms, low in toxicity to humans and other animals, and not harmful to the environment. Of the known antimicrobial agents, peroxygen compounds, e.g. hydrogen peroxide, appear to have exceptional potential due to their low toxicity and favourable environmental profile. Also, they tend to have broad spectrum antimicrobial activity which is important in situations where harmful organisms are present, but their identity is not known. Peroxygen-based antimicrobial compositions are useful in many different applications, including in hospitals, clinics, laboratories, dental offices, home care, and chronic care facilities. They may also be used in the preparation and processing of food and beverages, animal health and agriculture, the hospitality industry, personal care services such as spas, tattoo studios, etc., and for general sanitation, e.g. janitorial services.

To provide fast and effective action, prior art antimicrobial compositions, e.g. solutions, have had to employ relatively high concentrations of peroxygen compounds. At higher concentrations, the solutions may not be practical or economically viable, may be subject to hazardous goods regulations, and may require special precautions for handling and use. Solutions containing more than about 4.5% hydrogen peroxide can cause discoloration to skin and act as skin irritants. Lowering the concentration of the peroxygen compounds in the formulation will generally improve safety and material compatibility but will also generally reduce the antimicrobial effectiveness of the solution.

Though peroxygen-based antimicrobial compositions exist in the marketplace, there remains a need to develop new formulations that are safe, effective, and economically feasible.

### SUMMARY OF THE INVENTION

The invention provides compositions, e.g. solutions, that are intended to be environmentally-friendly, cost-effective, and useful in reducing the microbial load on animate and inanimate hard and soft surfaces, e.g. devices, tools, apparatus, furniture, countertops, floors, machines, skin, mucous membranes, animal hair or fur, and plant and animal matter.

Ready-to-use antimicrobial solutions according to embodiments of the invention have a pH of from about 0 to about 4.5, and comprise, consist essentially of, or consist of
a. at least one peroxygen compound in a concentration of from about 0.01 to about 4.5 wt. %;
b. at least one anionic surfactant selected from the group consisting of alkyl sarcosines and salts thereof having the formula (A):

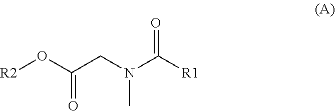

wherein R1 is a substituted or unsubstituted, saturated or unsaturated, branched or unbranched C8-24 alkyl, and R2 is a hydrogen or an alkaline moiety, in a concentration of from about 0.02 to about 8 wt. %;
c. optionally, at least one cyclic carboxylic acid selected from the group consisting of salicylic acid, 2-furoic acid, benzoic acid, and salts thereof, in a concentration of from about 0.02 to about 8 wt. %;
d. optionally, up to about 20 wt. % of at least one solvent;
e. optionally, an effective amount of at least one ingredient chosen from pH adjusting agents, buffering agents, dyes, fragrances, rheology modifiers, corrosion inhibitors, peroxide stabilizing agents, hydrotropes, non-ionic surfactants, other anionic surfactants, soil suspenders or anti-redeposition agents, skin conditioning agents, and additional antimicrobial agents; and
f. the balance water;
wherein the solution is free of percarboxylic acids and precursors thereof, essential oils, bleaching agents, low molecular weight organic diamines, cationic surfactants, C₁-C₄ aldehydes, ferrous salts, parabens, enzymes, and poly(alkylene glycol) alkyl ethers containing four or more ether linkages.

The solutions may be formulated in concentrated form for dilution with water or other diluents by the end user prior to use. In the concentrated versions, the at least one peroxygen compound may be present in a concentration of from about 2, 3, 4, 5, 6, 7, 8, 9, or 10 and up to about 20, 19, 18, 17, 16, 15, 14, 13, or 12 wt. %; the at least one anionic surfactant may be present in a concentration of from about 2, 3, 4, 5, 6, 7, 8, 9, or 10 and up to about 40, 38, 36, 34, 32, 30, or 28 wt. %; the optional at least one cyclic carboxylic acid may be present in a concentration of from about 1, 2, 3, 4, 5, 6, or 7, and up to about 15, 14, 13, 12, 11, 10, or 9 wt. %; and the optional at least one solvent may be present in a concentration of up to about 50, 48, 46, 44, 42, 40, 38, 36, 34, 32, or 30 wt. %.

The invention also provides a dry particulate antimicrobial composition (e.g. tablets, pods, powders, etc.) which, when dissolved in a diluent such as water, produces a solution according to embodiments of the present invention. The skilled person will be able to formulate dry forms of the present invention by way of routine experimentation based on the teachings herein.

Embodiments of the present invention are effective for use in sanitization, disinfection and/or sterilization. In some embodiments, the solution is effective to provide a greater than about 1-log order reduction in population of S. aureus at a contact time of up to about 5 minutes at about 20-25° C. using the ASTM E2197-02 test method.

According to another aspect, the invention provides a method of sanitizing, disinfecting, and/or sterilizing a surface comprising applying an effective amount of solutions according to embodiments of the invention to the surface. The method may include spraying or fogging using a fogging or misting machine or apparatus.

The invention also provides the use of antimicrobial solutions and compositions according to embodiments of the invention to sanitize, disinfect and/or sterilize a surface.

Solutions and/or compositions according to embodiments of the invention can be formulated as multi-part systems or kits wherein the ingredients are packaged separately and combined by the end user prior to use. The individual parts can be either a solid or a liquid. Furthermore, solutions according to the invention can be packaged in a dispenser, such as a spray or foam dispenser, or another suitable dispenser package, such as in the form of wipes (with the solution embedded in a textile).

Embodiments according to the present invention permit rapid and effective microbial kill with concentrations of the peroxygen compound lower than 4 wt. %. Some embodiments do not contain any added phosphorus-based compounds to comply with restrictions in some jurisdictions aimed at reducing the discharge of phosphorus into the environment. In other embodiments, phosphorus-based compounds are added in reduced quantities to minimize the harm to the environment.

### DETAILED DESCRIPTION OF THE EMBODIMENTS

For the sake of clarity and to avoid ambiguity, certain terms are defined herein as follows.

The term “comprising” means “including without limitation.” Thus, a composition comprising a list of ingredients may include additional ingredients not expressly recited. The term “consisting of” means “including the listed ingredients and such additional ingredients as may be present in the listed ingredients as natural or commercial impurities or additives.” Natural and commercial impurities and additives will be apparent to the person of ordinary skill in the art. For example, commercial hydrogen peroxide solutions contain minute quantities of hydrogen peroxide stabilizers. The term “consisting essentially of” means “consisting of the listed ingredients (as defined herein) plus such additional ingredients as would not materially affect the basic and novel properties of the solution.” By “basic and novel properties” is meant the ability of the antimicrobial solution to reduce the microbial load on a surface to be sanitized or disinfected. A change in efficacy (positively or negatively) of greater than 0.5 log using ASTM E2197-02 test method against S. aureus, at a contact time of up to about 5 minutes, at 20-25° C., would constitute a material effect.

The term “weight percent,” “wt. %,” “percent by weight,” “% by weight,” % w/w, and variations thereof, refer to the concentration of a substance as the weight of that substance divided by the total weight of the composition containing that substance, and multiplied by 100.

The term “about” refers to variations in an expressed numerical quantity that can occur, for example, through measuring and liquid handling procedures used for making concentrates or ready-to-use (RTU) solutions in the real world, differences in the manufacture, source, or purity of the ingredients used to make the compositions or carry out the procedures, due to different equilibrium conditions or different reaction levels for a composition resulting from an initial mixture. For the sake of clarity, the term “about” includes variations in the expressed value of ±5%. Whether a value is modified by the term “about,” the claims include equivalents to the values.

When used herein, the term “effective amount” means an amount that would bring about the desired effect, based on the purpose and function of the ingredient in the context of the present disclosure as determined from the standpoint of the skilled person having common general knowledge. What constitutes an effective amount will be determinable by the said skilled person without having to engage in inventive experimentation. For example, an effective amount of a pH adjusting agent is that amount which would cause the pH of the solution to reach the expressed value or ranges described and claimed herein.

In the description and claims, the singular forms “a,” “an,” and “the” include plural referents unless the context clearly dictates otherwise. Thus, for example, reference to a composition containing “a compound” includes a composition having two or more compounds. It should also be noted that the term “or” is generally employed in the sense of “and/or” unless the context clearly dictates otherwise.

The ranges of values recited herein are intended to include all values within the ranges. Thus, for example, a range of 0.01 to 4.5 wt. % is intended to include values such as 0.02, 0.03, 0.04, etc. wt. % and up to 4.4, 4.3, 4.2, etc. wt. %.

Unless otherwise specified, the term “alkyl” or “alkyl group” refers to hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups or “cycloalkyl” or “alicyclic” or “carbocyclic” groups (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups, etc.).

Also, unless otherwise specified, the term “alkyl” includes both “unsubstituted alkyls” and “substituted alkyls.” The term “substituted alkyls” refers to alkyl groups having substituents replacing one or more hydrogens on one or more carbons of the hydrocarbon backbone. Such substituents may include, for example, alkenyl, alkynyl, halogena, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonate, phosphine, cyano, amino (including alkyl amino, dialkylamino, arylamino, diarylamino, and alkylarylamino), acylamino (including alkylcarbonylamino, arylcarbonylamino, carbamoyl and uredo), amine, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including hetero aromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The present invention contemplates the possibility of omitting any components listed herein. The present invention further contemplates the omission of any components even though they are not expressly named as included or excluded from the invention. For example, the present solutions and composition can be substantially free of compounds or ingredients not expressly recited. As used herein, a solution or composition that is “substantially free of” one or more ingredients means that the solution or composition includes no more than trace or incidental amounts of those ingredients. Trace or incidental amounts of an ingredient can be found in another ingredient as an impurity or as a by-product of a side reaction during formation or degradation of a component of the composition. For the sake of clarity, ingredients present in a trace or incidental amount will not be present in excess of 0.5 wt. %, based on the total weight of the composition.

The chemical structures herein are drawn according to the conventional standards known in the art. Thus, where an atom, such as a carbon atom, as drawn appears to have an unsatisfied valency, then that valency is assumed to be satisfied by a hydrogen atom, even though that hydrogen atom is not necessarily explicitly drawn. The structures of some of the compounds of this invention include stereogenic carbon atoms. It is to be understood that isomers arising from such asymmetry (e.g., all enantiomers and diastereomers) are included within the scope of this invention unless indicated otherwise. That is, unless otherwise stipulated, any chiral carbon center may be of either (R)- or (S)-stereochemistry. Such isomers can be obtained in substantially pure form by classical separation techniques and by stereochemically-controlled synthesis. Furthermore, alkenes can include either the E- or Z-geometry, where appropriate. In addition, the compounds of the present invention may exist in unsolvated as well as solvated forms with acceptable solvents such as water, propylene glycol, ethanol, and the like. In general, the solvated forms are considered equivalent to the unsolvated forms for the purposes of the present invention.

As used herein, the term “microorganism” is used to refer to any noncellular or unicellular (including colonial) organism. Microorganisms include all prokaryotes, i.e. bacteria (including cyanobacteria), lichens, yeasts, fungi, protozoa, virinos, viroids, viruses, phages, spores and some algae.

Embodiments of the invention are “effective” against microorganisms. By this is meant that the embodiments can bring about a reduction in the population of microorganisms by at least about 90% as compared to what is achieved by flushing with water or other antimicrobially inert compositions. Larger reductions in the microbial population will provide greater levels of protection.

Some embodiments are “sanitizers,” “disinfectants,” “sterilants”, and/or “sporicides.” “Sanitizer” means an agent that reduces the number of bacterial contaminants to safe levels as judged by public health requirements. In an embodiment, sanitizers for use in this invention will provide at least a 99.9% reduction (3-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). “Disinfectant” refers to an agent that kills most vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). “Sterilant” refers to an agent that destroys all viable forms of microbial life. “Sporicide” refers to a physical or chemical agent or process having the ability to cause greater than a 90% reduction (1-log order reduction) in the population of spores of Bacillus subtilis, Clostridium difficile, or Clostridium sporogenes within 30 minutes at room temperature.

“Hard surfaces” include but are not limited to glass, ceramics, metal, natural and synthetic rock, wood, and certain polymers, elastomers, and plastics. “Soft surfaces” include but are not limited to woven and non-woven substrates, a food product (and its surfaces), a body or stream of water or a gas (e.g., an air stream), and the body of a living creature or part thereof, e.g. a human hand. Both hard and soft surfaces are encountered in the human and animal healthcare, hospitality, agriculture, food processing, and other industrial sectors.

Peroxygen Compounds

The present solution includes at least one peroxygen compound in an amount from about 0.01, 0.1, 0.5, 0.8, 1, 1.5, 2, 2.5, 3, 3.5, 4, or 4.5 wt. % and up to about 20, 18, 16, 14, 12, 10, 8, 7, 6, 5, 4.5, or 4 wt. %. The amount of the peroxygen compound will generally not be more than about 4.5 wt. % in ready-to-use solutions, and generally not less than about 2 wt. % in concentrated solutions.

When used herein, a “peroxygen compound” is a compound containing an oxygen-oxygen single bond or the peroxide anion:

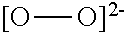

Examples include alkali metal peroxides (e.g. sodium peroxide).
Also included are compounds that generate and release hydrogen peroxide when dissolved in aqueous solution, e.g. urea peroxide, perboric acid, sodium/potassium perborate, sodium persulfate, calcium peroxide, lithium peroxide, sodium peroxide, or other peroxides of alkali, alkaline earth, or transition group metals or salts thereof.

Still other examples are compounds according to the following formulas I and II:

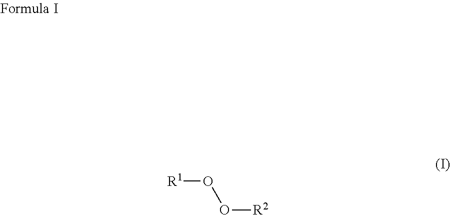

wherein R1 and R2 are independently a substituted or unsubstituted, branched or unbranched, saturated or unsaturated, cyclic or linear alkyl group. R1 and R2 may be connected to form a cyclic structure. Examples include dialkyl peroxides such as dibenzoyl peroxide, diacetyl peroxide, di(n-propyl) peroxydicarbonate, butyl peroxybenzoate, and many others commercially available, without limitation, under the brand name Luperox™. In certain cases, the R1 and R2 can be sulfurous or phosphorus atoms (e.g. peroxidisulfuric acid).

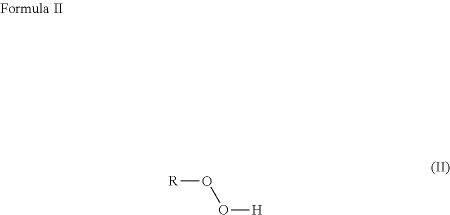

wherein R is H or a substituted or unsubstituted, branched or unbranched, saturated or unsaturated, cyclic or linear alkyl group. Examples include, without limitation, hydrogen peroxide, butyl hydroperoxide, ethylidene peroxide, and ethyl hydroperoxide. In certain cases, the R can be sulfurous or phosphorus atoms (e.g. peroximonosulfuric acid).

Preferred peroxygen compounds are hydrogen peroxide, sodium peroxide, benzoyl peroxide, dibenzyl peroxides, percarbonates (e.g. sodium percarbonates, potassium percarbonates), peroxymonosulfuric acid, and peroxydisulfuric acid.

Alkyl Sarcosines and Salts Thereof

The present inventive compositions have at least one anionic surfactant selected from the group consisting of alkyl sarcosines and salts thereof. The alkyl sarcosines and salts thereof have been surprisingly found to synergistically enhance the antimicrobial efficacy of solutions containing a peroxygen compound. Consequently, products can be formulated with lower amounts of the peroxygen compound while still being effective against microorganisms.

These compounds have the following general formula (A):

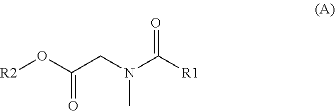

wherein R1 is a substituted or unsubstituted, saturated or unsaturated, branched or unbranched C8-24 alkyl, and R2 is a hydrogen or an alkaline moiety. By alkaline moiety is meant an electropositive molecule and/or atom that is able to react with the electronegative carboxylic acid group found in alkyl sarcosinates and form an ionic bond (the bond between oxygen and R2 in Formula A, when R2 is not a hydrogen), resulting in formation of an alkyl sarcosinate salt. Examples of alkaline moieties include lithium, sodium, potassium, calcium, barium, magnesium, beryllium, manganese, zinc, and ammonium. Examples of these anionic surfactants include cocoyl sarcosine, lauroyl sarcosine, oleoyl sarcosine, myristoyl sarcosine, stearoyl sarcosine, and salts thereof.

The alkyl sarcosine or salt thereof can be present in a concentration of from about 0.02, 0.05, 0.15, 0.5, 1.0, 1.5, 2, 3, 4, 6, or 8 wt. %, and up to about 40, 30, 20, 10, 8, 6, 4, 3, or 2 wt. %. The surfactant will generally not be more than 8 wt. % in ready-to-use solutions, or less than 1 wt. % in concentrated versions of the solution.

Optional Ingredients

The present inventive compositions may include an effective amount of one or more additional ingredients as would be apparent to the person skilled in the art, including without limitation, carboxylic acids, solvents, peroxide stabilizing agents, pH adjusting agents, buffering agents, nonionic surfactants, other anionic surfactants, hydrotropes, other antimicrobial compounds, skin conditioning agents, anti-foaming agents, builders, soil suspenders and anti-redeposition agents, brightening agents or brighteners, radical scavengers, dyes, fragrances, rheology modifiers, corrosion inhibitors, anti-foaming agents, softening agents, anti-static agents, anti-wrinkling agents, dye transfer inhibition/color protection agents, odor removal/odor capturing agents, chelating agents, preservatives, soil shielding/soil releasing agents, ultraviolet light protection agents, water repellency agents, insect repellency agents, anti-pilling agents, souring agents, mildew removing agents, allergicides, and mixtures thereof.

Carboxylic Acids

In some embodiments, the solutions or compositions may comprise at least one cyclic or linear, branched or unbranched, saturated or unsaturated, substituted or unsubstituted, mono-, di- or poly-carboxylic acid to enhance the antimicrobial activity. The carboxylic acid may be chosen from C1 to C22 carboxylic acids. In some embodiments, the carboxylic acid may be a C5 to C11 carboxylic acid. In some embodiments, the carboxylic acid may be a C1 to C4 carboxylic acid. Examples of suitable carboxylic acids include but are not limited to 2-furoic acid, salicylic acid, benzoic acid, citric acid, sulfosalicylic acid, sulfosuccinic acid, glycolic acid, lactic acid, formic acid, oxalic acid, malic acid, acetic acid, propionic acid, butanoic acid, pentanoic acid, hexanoic acid, heptanoic acid, octanoic acid, nonanoic acid, decanoic acid, undecanoic acid, dodecanoic acid, as well as their branched isomers, maleic acid, ascorbic acid, alpha-or-beta hydroxy-acetic acid, neopentanoic acid, neoheptanoic acid, neodecanoic acid, malonic acid, succinic acid, glutaric acid, adipic acid, pimelic suberic acid, and mixtures thereof. Some embodiments will have at least one acid and/or salt selected from the group consisting of salicylic acid, 2-furoic acid, benzoic acid, and salts thereof.

The acid and/or salt may be present in a concentration of from about 0.02, 0.05, 0.1, 0.5, or 1 wt. % and up to about 15, 13, 10, 8, 6, 4, or 3 wt. %. The acid and/or salt will generally not be higher than 8 wt. % in ready-to-use solutions, or lower than 1 wt. % in concentrated solutions.

Solvents

Solvents are optional in the present formulations. However, effective amounts can be employed for various purposes, including, to enhance cleaning and/or to help solubilize ingredients in the solution.

Exemplary solvents include cyclic alcohols (e.g. phenethyl alcohol, benzyl alcohol, phenoxyethanol, and cyclopentylmethanol), carbonates (e.g. ethylene carbonate, propylene carbonate, butylene carbonate, glycerin carbonate, and dimethyl succinate), benzyl acetate, benzyl benzoate, acetophenone, 2-acetyl-1-methylpyrrole, diester dicarboxylates (e.g., dibasic esters, such as dialkyl adipate, dialkyl glutarate, dialkyl succinate), dialkyl carbonate, organo-nitriles, phthalate esters, propylene glycol derivatives with ethoxylation and/or propoxylation, alkoxytriglycols and other glycols such as methoxytriglycol, ethoxytriglycol, butoxytriglycol, hexyltriglycol, propylene glycol methyl ether acetate, dipropylene glycol methyl ether acetate, dipropylene glycol n-butyl ether, propylene glycol n-butyl ether, dipropylene glycol n-propyl ether, propylene glycol n-propyl ether, dipropylene glycol methyl ether, tripropylene glycol methyl ether, methanol, ethanol, butyl 3-hydroxybutyrate, isopropyl alcohol, ethylhexylglycerol, branched or unbranched diols, charged or uncharged non-surfactant emulsifying agents, polar protic solvents, polar aprotic solvents, diethylene glycol monobutyl ether, diethylene glycol monoethyl ether, butyl pyrrolidone, C₁-C₈ alcohols (e.g. methanol, ethanol, propanol, butanol, etc.) and mixtures thereof.

The solvent may be present in a concentration of from about 0.01, 0.5, 1, 2.5, 5, 7, 9 or 10 wt. % and up to about 50, 40, 30, 20, 18, 16, or 14 wt. %. The solvent will generally not be more than about 20 wt. % in ready-to-use solutions, or more than about 50 wt. % in concentrated solutions.

Peroxide Stabilizing Agents

Peroxide stabilizing agents can be included where stabilization of the peroxide compounds is desired or necessary. These include 1-hydroxyethane-1,1-diphosphonic acid (HEDP, also referred to herein as etidronic acid), ethylenediaminetetraacetic acid (EDTA), glutamic acid diacetic acid (GLDA), methylglycine diacetic acid (MGDA), polymandelic acid, diethylenetriaminepentaacetic acid (DTPA), N-(hydroxyethyl)-ethylenediaminetriacetic acid (HEDTA), nitrilotriacetic acid (NTA), 2-hydroxyethyliminodiacetic acid (HEIDA), benzoic acid, aminobenzoic acid, citric acid, iminodisuccinic acid, polyaspartic acid, phosphoric acid, tripolyphosphate, amino tri(methylene phosphonic acid) (ATMP), diethylenetriaminepenta(methylene phosphonic acid), 2-hydroxy ethylimino bis(methylene phosphonic acid), ethylene diamine tetra(methylene phosphonic acid), hexamethylenediamine-tetra(methylene phosphonic) acid, and salts thereof. The skilled person will appreciate that certain of these peroxide stabilizing agents are also classified as chelating agents (e.g. HEDP, EDTA, etc.).

When used, peroxide stabilizing agents can be present in a concentration of from about 0.005, 0.1, 1, 5, or 10 wt. % and up to about 20, 17.5, 12.5, 7.5, or 2.5 wt. %.

pH Adjusting and Buffering Agents

Solutions according to the invention can optionally contain at least one pH adjusting agent and/or buffering agent in an amount effective to adjust and/or keep the pH of the solution to within the pH ranges recited herein.

Examples include, without limitation, inorganic acids (e.g. phosphoric acid) and salts thereof, organic acids (e.g. citric acid, methane sulfonic acid, p-toluene sulfonic acid) and salts thereof, and alkaline agents (e.g. potassium hydroxide and sodium hydroxide).

Embodiments of the invention have a pH of from about 0, 0.4, 0.6, 0.75, 1, 1.5, or 1.7, and up to about 4.5, 4, 3.7, 3.5, 3.2, 3, 2.8, 2.7, 2.6, 2.5, 2.3, 2.2, 2.0, or 1.8.

Buffering agents may be present in a concentration of from about 0.01, 0.5, 1, 5, or 7 wt. %, and up to about 15, 10, 5, 3, 0.1, or 0.05 wt. %.

Nonionic Surfactants

To enhance cleaning, nonionic surfactants that are compatible with peroxygen compounds can be added. Some of these nonionic surfactants can also be used as solvents.

Suitable nonionic surfactants include alkoxylated surfactants such as alkoxylates made from ethylene oxide (EO), propylene oxide (PO), and butylene oxide (BO). Suitable alkoxylated surfactants include homo or copolymers or terpolymers, capped EO/PO/BO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates such as Dehypon LS-54, and Dehypon LS-36 capped alcohol alkoxylates, such as Plurafac LF221 and Tegoten EC11. More specifically, the composition of the present invention can include alkoxylated primary or secondary alcohol having from 8 to 18 carbon atoms reacted with from 2 to 12 moles of ethylene, and/or propylene, and/or butylene oxide. In an embodiment, the nonionic surfactant has from 3 to 18 moles of alkylene oxides, in another embodiment from 3 to about 10 moles of ethylene oxide, and in yet another embodiment about 7 moles of EO. These materials are commercially available and well-known nonionic surfactants. The following materials are useful: lauryl alcohol ethoxylated with 3 moles of ethylene oxide (EO), coco alcohol ethoxylated with 3 moles EO, stearyl alcohol ethoxylated with 5 moles EO, mixed C₁₂-C₁₅ alcohol ethoxylated with 7 moles EO, mixed secondary C₁₁-C₁₅ alcohol ethoxylated with 7 moles EO, mixed C₉-C₁₁ linear alcohol ethoxylated with 6 moles EO and the like. In an embodiment the nonionic has from 8 to 15 carbon atoms in the alkyl group. When this alkyl group is used a nonionic is the mixed C₁₂-C₁₅ alcohol ethoxylated with 7 moles EO. In an embodiment it comprises the alcohol alkoxylates, particularly the alcohol ethoxylates and propoxylates, especially the mixed ethoxylates and propoxylates, particularly with 3-7 oxyethylene (EO) units and 3-7 oxypropylene (PO) units such as the alcohol Dehypon™ available from Cognis Corporation, having 5 EO units and 4 PO units. These materials may be present in a wide range of concentrations, such as, for example, from 0.1 to 25% by weight of the concentrate or solution, from 1 to 25% by weight of the concentrate or solution, 1 to 20% by weight of the concentrate or solution, 2 to 15% by weight of the concentrate or solution, or 4 to 12% by weight of the concentrate or solution.

Nonionic surfactants also include synthetic or natural alcohols that are alkoxylated (with ethylene and/or propylene and/or butylenes oxide) to yield a variety of C₆-C₂₄ alcohol ethoxylates and/or propoxylates and/or butoxylates (preferably C₆-C₁₄ alcohol ethoxylates and/or propoxylates and/or butoxylates having 1 to about 20 alkylene oxide groups (preferably about 9 to about 20 alkylene oxide groups); C₆-C₂₄alkylphenol ethoxylates (preferably C₈-C₁₀ alkylphenol ethoxylates) having 1 to about 100 ethylene oxide groups (preferably about 12 to about 20 ethylene oxide groups); and C₆-C₂₄ alkylpolyglycosides (preferably C₆-C₂₀ alkylpolyglycosides) having 1 to about 20 glycoside groups (preferably about 9 to about 20 glycoside groups).

The semi-polar type of nonionic surface-active agents are another class of nonionic surfactant useful in compositions of the present invention. Semi-polar nonionic surfactants include the amine oxides (e.g. tertiary amine oxides), phosphine oxides, sulfoxides and their alkoxylated derivatives.

Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylamine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

When used, the concentration of the nonionic surfactant may be from about 0.02, 0.1, 1, 5, 10, or 20 wt. %, and up to about 30, 20, 15, 8, 3, or 0.5 wt.

Other Anionic Surfactants

To enhance cleaning and/or antimicrobial efficacy, other anionic surfactants can be added to solutions or compositions according to the invention. These include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, glucamine sulfates, and sulfates of alkylpolysaccharides such as the sulfates of alkylpolyglucoside, and the like. Also included are alkyl poly(ethyleneoxy)ether sulfates and aromatic poly(ethyleneoxy) sulfates such as the sulfates or condensation products of ethylene oxide and nonyl phenol (usually having 1 to 6 oxyethylene groups per molecule).

Anionic sulfonate surfactants suitable for use in the present solution or composition also include alkyl sulfonates, the linear and branched primary and secondary alkyl sulfonates, and the aromatic sulfonates with or without substituents; including alkylbenzene sulfonates.

Anionic carboxylate surfactants suitable for use in the present solution or composition include carboxylic acids (and salts), such as alkanoic acids (and alkanoates), ester carboxylic acids (e.g. alkyl succinates), ether carboxylic acids, and the like. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylglutamates, acyl peptides, taurates (e.g. N-acyl taurates and fatty acid amides of methyl tauride), and the like.

Suitable anionic surfactants include alkyl or alkylaryl ethoxy carboxylates such as those available commercially in association with the trademarks or trade names Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g. the product Sandopanr DTC, a C₁₃ alkyl polyethoxy (7) carboxylic acid.

Anionic surfactants include C₆-C₂₄ alkylbenzene sulfonates; C₆-C₂₄ olefin sulfonates; C₆-C₂₄ paraffin sulfonates; cumene sulfonate; xylene sulfonate; C₆-C₂₄ alcohol sulfates (preferably C₆-C₁₂ alcohol sulfates); and C₆-C₂₄ alcohol ether sulfates having 1 to about 20 ethylene oxide groups.

Other suitable anionic surfactants include alkyl phosphonates, alkyl ether phosphonates, alkyl phosphates, alkyl ether phosphates, and phosphate esters.

When used, the concentration of the additional anionic surfactant may be from about 0.02, 0.1, 1, 5, 10, or 20 wt. %, and up to about 40, 30, 20, 15, 8, 3, or 0.5 wt. %.

Hydrotropes

The solution or composition of the invention may include one or more hydrotropes for improving solubility and phase stability. The hydrotrope includes, without limitation, salts of aryl and alkylaryl sulfonic acids such as xylene sulfonic acid, cumene sulfonic acid, toluene sulfonic acid. Other hydrotropes include polyether phosphate esters, alkyl sulfates, alkyl and alkylaryl sulfonates, diphenyloxide disulfonates, and benzoic acid salts.

When used, the hydrotrope can be present in a concentration of from about 0.1, 1, 3, 5, 10, or 20 wt. % and up to about 25, 15, 8, 4, or 1.5 wt. %.

Other Antimicrobial Compounds

In other embodiments, the solutions or compositions may include an effective amount of an additional antimicrobial compound (e.g. sanitizing or disinfecting agent) for killing microorganisms and the like. The antimicrobial compound may be chosen from and is not limited to inorganic and organic acids, aldehydes (other than C₁-C₄ aldehydes), phenolic compounds (other than those that are essential oils), alcohols, biguanides, or mixtures thereof.

When used, the concentration of the antimicrobial compound may be from about 0.005, 0.1, 1, 5, 10, or 20 wt. %, and up to about 40, 30, 20, 15, 8, 3, or 0.5 wt %.

Skin Conditioning Agents

In embodiments for use on skin, the solution may include an effective amount of at least one emollient, humectant or skin conditioning agent, including but not limited to glycerin, poly-glycerin, butylene glycol, glycerides, castor oil, allantoin, cationic polymers, lanolin and its derivatives, polyols and glycols such as glycerol, polyglycerol, sorbitol, mannitol, erythritol, xylitol, arabitol, ribitol, dulcitol, lactitol, maltitol, propylene glycol, hexylene glycol, ceramides, essential fatty acids such as linolenic acid, gamma-linolenic acid, linoleic acid, gamma-linoleic acid, tocopherols such as tocopheryl acetate, quaternised gums, quaternised polymers, glucose-ethers, vegetable oils, long chain fatty acids, long chain alcohols (e.g. cetyl alcohol), and phospholipids, and mineral oils.

When used, the skin conditioning agent may be present in a concentration of from about 0.01, 0.5, 2, 5, or 10 wt. %, and/or up to about 30, 25, 20, 15, 8, 4, or 1 wt. %.

Anti-Foaming Agents, Etc.

Anti-foaming agents, including but not limited to siloxanes, low-solubility oils, low-HLB nonionic surfactants, may be present in a concentration of from about 0.001, 0.1, 0.5, 2, 4, 5, or 7 wt. %, and up to about 20, 10, 8, 5, 4, or 3 wt. %.

Builders may be present in a concentration of from about 0.01, 0.5, 2, 4, or 5 wt. %, and up to about 8, 3, 1, or 0.1 wt. %.

Soil suspenders may be present in a concentration of from about 0.01, 0.5, 2, 5, or 10 wt. %, and up to about 15, 8, 4, 1, or 0.1 wt. %.

Brighteners may be present in a concentration of from about 0.0005, 0.05, 0.1, 2, or 7 wt. %, and up to about 10, 5, 3, 1, or 0.01 wt. %.

Radical scavengers may be present in a concentration of from about 0.005, 0.5, 1, 5, or 15 wt. %, and up to about 20, 10, 3, 0.1, or 0.01 wt. %.

The following examples will help to further illustrate the utility and novelty of the invention.

### EXAMPLES

The raw ingredients listed in Table A below are used in the following examples summarized in Tables 1-5.

TABLE A

| | Ingredient Identity_Brand Name_Commercial |
|---|---|
| Classification | Source (% w/w active) |
| Alkyl Sarcosinate and | Lauroyl Sarcosine Sodium Salt_N/A_Sigma |
| Salt Thereof | Aldrich (≥94% w/w active) |
| | Lauroyl Sarcosine_Hamposyl L_Chattem |
| | Chemicals Inc._(≥94% w/w active) |
| | Cocoyl Sarcosine_Hamposyl C_Chattem |
| | Chemicals Inc._(≥94% w/w active) |
| Other Anionic | Sodium Caprylyl Sulfonate_BIO-TERGE |
| Surfactant | PAS-8S_Stepan Company (37.8% w/w active) |
| Cyclic Carboxylic Acid | Salicylic acid_N/A_Sigma Aldrich (≥99% w/w |
| | active) |
| Peroxygen Source | Hydrogen Peroxide_Peroxal 50 BIO_ |
| | Arkema (50% w/w active) |
| Nonionic Surfactant | Polyoxypropylene-polyethylene block |
| | copolymer_Pluronic L62_BASF Corporation |
| | (100% w/w active) |
| | Alcohols, C9-11, ethoxylated (EO = 6)_ |
| | Tomadol 91-6_Air Products (100% w/w active) |
| | Alkyl polyglucosides C10-C16_Glucopon |
| | 600UP_BASF Corporation_(50% w/w active) |
| Amine-based or | Etidronic acid_Dequest 2010_Italmatch |
| phosphonate-based | Chemicals (60% w/w active) |
| chelating agent | L-glutamic acid N,N-diacetic acid, |
| | tetrasodium salt_AkzoNobel_Dissolvine GL- |
| | 47-S (48% w/w active) |
| Solvents | Tripropylene glycol methyl ether_Dowanol |
| | TPM_Dow Chemicals (≥97.5% w/w active) |
| | Propylene carbonate_N/A_Sigma Aldrich |
| | (≥98% w/w active) |
| Hydrotrope | Sodium Xylene Sulfonate_Stepanate SXS_ |
| | Stepan Company (41% w/w active) |
| pH Adjusting Agent | Potassium hydroxide_N/A_Sigma Aldrich |
| | (45% w/w active) |
| | Phosphoric acid_N/A_Sigma Aldrich (75% |
| | w/w active) |
| | p-Toluene sulfonic acid, monohydrate_N/A_ |
| | Sigma Aldrich (≥98.5% w/w active) |
| | Methane sulfonic acid_Lutropur MSA 100_ |
| | BASF Corporation (≥99% w/w active) |
| Solvent/Diluent/Base | Deionized Water |
| Carrier | |

Tables 1-5 (below) show solutions that were formulated and tested using ASTM E2197-02. pH adjusting agents, when present, were used in amounts effective to achieve the pH specified in the tables. The amount of each ingredient is shown in terms of the wt. % of the raw material shown in Table A based on the total weight of the solution. To calculate the actual concentration of each ingredient in the solution, reference must be made to the concentration of the active ingredient in the raw material shown in Table A (above). For example, referring to Table 1, Solutions 2 and 3 contain 0.5 wt. % hydrogen peroxide calculated as follows: 1 wt. % (from Table 1)×50 wt. % (from Table A)=0.5 wt. %. Furthermore, each solution in the examples contains deionized water q.s. to 100.

### Example 1

Solutions 1-3 were tested against a gram positive bacteria, S. aureus, at a contact time of 3 minutes at room temperature (about 20-25° C.). Of these solutions, only Solution 3 is in accordance with the present invention.

TABLE 1

| Solution | 1 | 2 | 3 |
|---|---|---|---|
| Hydrogen Peroxide | — | 1.0 | |
| Lauroyl Sarcosine | 0.164 | — | 0.164 |
| Sodium Salt | | | |
| p-Toluene sulfonic | Effective amount to | | |
| acid | adjust the pH | | |
| pH | 3.7 | | |
| Log Reduction | 0.28 | 0.1 | 1.46 |

As shown above, the log reduction of Solution 3 is surprisingly greater than the sum of the log reductions of Solutions 1 and 2. This demonstrates a synergy between hydrogen peroxide and the lauroyl sarcosine sodium salt.

### Example 2

A base formula, Solution 4, was prepared as shown in Table 2. Solution 4 is not in accordance with the invention. Solutions 5 and 6 are in accordance with the invention and contain additions to the base formula. These solutions were tested against S. aureus at a contact time of 1 minute and 2 minutes at room temperature (about 20-25° C.). No pH adjusting agent was used in these examples.

TABLE 2

| Solution | 4 | 5 | 6 |
|---|---|---|---|
| Etidronic acid | 0.5 | | |
| Phosphoric acid | 0.15 | | |
| Alkyl | 0.2 | | |
| polyglucosides | | | |
| C10-C16 | | | |
| Hydrogen Peroxide | 1.0 | | |
| Lauroyl Sarcosine | — | — | 0.156 |
| Lauroyl Sarcosine | — | 0.164 | — |
| Sodium Salt | | | |
| pH | 1.81 | 1.81 | 1.63 |
| Log Reduction | 1.255 | 2.755 | 2.045 |
| (1 min) | | | |
| Log Reduction | 3.11 | 6.4 | 5.28 |
| (2 min) | | | |

As shown above, the addition of the lauroyl sarcosine or its sodium salt led to a significant boost in antimicrobial efficacy of the base formula.

### Example 3

Solutions 7-13 were formulated to determine the effect of pH on the antimicrobial efficacy of the solution and to further assess the synergy between hydrogen peroxide and an alkyl sarcosinate surfactant. Of these solutions, all except for Solutions 12 and 13 are in accordance with the invention. These solutions were tested against S. aureus at a contact time of 1 minute at room temperature (about 20-25° C.).

TABLE 3

| | Solution | | | | | | |
|---|---|---|---|---|---|---|---|
| | 7 | 8 | 9 | 10 | 11 | 12 | 13 |
| Sodium Caprylyl | 0.05 | | | | | | — |
| Sulfonate | | | | | | | |
| Glutamic acid N,N- | 0.1 | | | | | | — |
| diacetic acid, | | | | | | | |
| tetrasodium salt | | | | | | | |
| Sodium Xylene | 0.33 | | | | | | — |
| Sulfonate | | | | | | | |
| Tripropylene glycol | 3 | | | | | | — |
| methyl ether | | | | | | | |
| Polyoxypropylene- | 0.33 | | | | | | — |
| polyethylene block | | | | | | | |
| copolymer | | | | | | | |
| Propylene | 3 | | | | | | — |
| carbonate | | | | | | | |
| Alcohols, C9-11, | 0.33 | | | | | | — |
| ethoxylated (EO = 6) | | | | | | | |
| Hydrogen Peroxide | 1.0 | | | | | | — |
| Lauroyl Sarcosine | 0.164 | | | | | — | 0.164 |
| Sodium Salt | | | | | | | |
| p-Toluene sulfonic | Effective amount to adjust the pH | | | | | | |
| acid | | | | | | | |
| pH | 1.7 | 2.5 | 3.0 | 3.5 | 4.0 | | |
| Log reduction | 1.79 | 1.93 | 2.04 | 1.89 | 2.25 | 0.9 | 0.38 |

The results for Solutions 7 to 10 show that changing the pH to the values indicated does not materially affect the base synergistic antimicrobial efficacy of the solution.

Solutions 12 and 13 are not in accordance with the invention. Solution 12 does not contain the lauroyl sarcosine sodium salt. Solution 13 does not contain hydrogen peroxide. Both solutions are far less effective than Solution 11, which contains both the lauroyl sarcosine sodium salt and hydrogen peroxide. These results also demonstrate the synergy between these ingredients as the log reduction for Solution 11 (2.25) is greater than the sum of the log reductions (0.9+0.38) of Solutions 12 and 13.

### Example 4

Phosphorous-based acids can have antimicrobial properties. Solutions 14-20 were formulated to determine the effect of pH and phosphorous-based acids (etidronic acid and phosphoric acid) on the antimicrobial efficacy of the solution. These solutions are all in accordance with the invention and were tested against a gram negative bacteria, A. baumannii, at a contact time of 1 minute at room temperature (about 20-25° C.).

TABLE 4

| | Solution | | | | | | |
|---|---|---|---|---|---|---|---|
| | 14 | 15 | 16 | 17 | 18 | 19 | 20 |
| Etidronic acid | — | | 0.5 | | | | |
| Glutamic acid N,N- | 0.1 | | — | | | | |
| diacetic acid, | | | | | | | |
| tetrasodium salt | | | | | | | |
| Phosphoric acid | — | | 0.15 | | | | |
| Tripropylene glycol | 2.5 | | | | | | |
| methyl ether | | | | | | | |
| Alkyl polyglucosides | 0.2 | | | | | | |
| C10-C16 | | | | | | | |
| Hydrogen Peroxide | 1.0 | | | | | | |
| Lauroyl Sarcosine | 0.156 | — | 0.156 | | | | |
| Lauroyl Sarcosine | — | 0.164 | — | | | | |
| Sodium Salt | | | | | | | |
| Methane sulfonic | Effective amount to adjust the pH | | | | | | |
| acid | | | | | | | |
| pH | 2.2 | | 1.8 | 2.0 | 2.2 | 2.5 | 2.7 |
| Log reduction | 2.18 | 2.31 | 4 | 3 | 2.44 | 2.79 | 2.34 |

Solutions 14 and 18 have the same pH (2.2); however, Solution 14 has no phosphorous-based acids, whereas Solution 18 has both etidronic acid and phosphoric acid. The results for these solutions show that the phosphorous-based acids do not materially affect the base synergistic antimicrobial efficacy of the solution.

The pH was gradually adjusted in Solutions 16-20 from 1.8 to 2.7. The results for these solutions show that lowering the pH to 1.8 can lead to a material enhancement in antimicrobial activity.

The results for Solutions 14 and 15 show that either the acid or salt form of the alkyl sarcosine surfactant can be used in solutions according to the invention.

### Example 5

Solutions 21 and 22 were formulated to determine the effect of pH on the antimicrobial efficacy of the solution. These solutions are all in accordance with the invention and were tested against A. baumannii at a contact time of 1 minute at room temperature (about 20-25° C.). Solution 21 was also tested against a yeast and fungus, C. albicans, at a 2-minute contact time.

TABLE 5

| Solution | 21 | 22 |
|---|---|---|
| Etidronic acid | 0.04 | |
| Alcohols, C9-11, | 0.15 | |
| ethoxylated (EO = 6) | | |
| Alkyl polyglucosides | 0.06 | |
| C10-C16 | | |
| Sodium Xylene | 0.4 | |
| Sulfonate | | |
| Propylene Carbonate | 0.4 | |
| Salicylic acid | 0.12 | |
| Hydrogen Peroxide | 1.0 | |
| Lauroyl Sarcosine | 0.16 | |
| Sodium Salt | | |
| Methane sulfonic acid | Effective amount to | |
| | adjust the pH | |
| pH | 2.2 | 3.2 |
| Log reduction of A. | 2.59 | 2.26 |
| baumannii | | |
| Log reduction of C. | >4.61 | Not |
| albicans | | tested |

The above results show that changing the pH from 2.2 to 3.2 did not materially affect the microbicidal properties of Solutions 21 and 22 against A. baumannii under these test conditions. Furthermore, Solution 21 was also shown to be effective as against the yeast and fungus, C. albicans.

The foregoing description of embodiments is by way of example only and is not intended to limit the scope of the invention as herein described and claimed.

1. A ready-to-use antimicrobial solution having a pH of from about 0 to about 4.5, comprising, consisting essentially of, or consisting of:
a. at least one peroxygen compound in a concentration of from about 0.01 to about 4.5 wt. %;
b. at least one anionic surfactant selected from the group consisting of alkyl sarcosines and salts thereof having the formula (A): 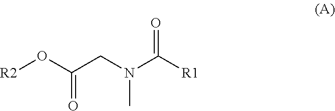
wherein R1 is a substituted or unsubstituted, saturated or unsaturated, branched or unbranched C8-24 alkyl, R2 is a hydrogen or an alkaline moiety, in a concentration of from about 0.02 to about 8 wt. %;
c. optionally, at least one carboxylic acid in a concentration of from about 0.02 to about 8 wt. %;
d. optionally, up to about 20 wt. % of at least one solvent;
e. optionally, an effective amount of at least one ingredient chosen from pH adjusting agents, buffering agents, dyes, fragrances, rheology modifiers, corrosion inhibitors, peroxide stabilizing agents, hydrotropes, non-ionic surfactants, other anionic surfactants, soil suspenders or anti-redeposition agents, skin conditioning agents, and additional antimicrobial agents; and
f. the balance water;
wherein the solution is free of percarboxylic acids and precursors thereof, essential oils, bleaching agents, low molecular weight organic diamines, cationic surfactants, C₁-C₄ aldehydes, ferrous salts, parabens, enzymes, and a poly(alkylene glycol) alkyl ethers containing four or more ether linkages.

2. The antimicrobial solution of claim 1, wherein the at least one solvent is chosen from phenethyl alcohol, benzyl alcohol, phenoxyethanol, cyclopentylmethanol, ethylene carbonate, propylene carbonate, butylene carbonate, glycerin carbonate, methoxytriglycol, ethoxytriglycol, butoxytriglycol, hexyltriglycol, propylene glycol methyl ether acetate, dipropylene glycol methyl ether acetate, dipropylene glycol n-butyl ether, propylene glycol n-butyl ether, dipropylene glycol n-propyl ether, propylene glycol n-propyl ether, dipropylene glycol methyl ether, tripropylene glycol methyl ether, butyl 3-hydroxybutyrate, ethylhexylglycerol, benzyl acetate, benzyl benzoate, acetophenone, 2-acetyl-1-methylpyrrole, dialkyl adipate, dialkyl glutarate, dialkyl succinate, dialkyl carbonate, diethylene glycol monobutyl ether, diethylene glycol monoethyl ether, butyl pyrrolidone, and C₁-C₈ alcohols.

3. The antimicrobial solution of claim 1, wherein the at least one solvent is chosen from phenethyl alcohol, benzyl alcohol, phenoxyethanol, cyclopentylmethanol, ethylene carbonate, propylene carbonate, butylene carbonate, glycerin carbonate, methoxytriglycol, ethoxytriglycol, butoxytriglycol, hexyltriglycol, propylene glycol methyl ether acetate, dipropylene glycol methyl ether acetate, dipropylene glycol n-butyl ether, propylene glycol n-butyl ether, dipropylene glycol n-propyl ether, propylene glycol n-propyl ether, dipropylene glycol methyl ether, tripropylene glycol methyl ether, butyl 3-hydroxybutyrate, benzyl acetate, benzyl benzoate, 2-acetyl-1-methylpyrrole, dialkyl adipate, dialkyl glutarate, dialkyl succinate, dialkyl carbonate, diethylene glycol monobutyl ether, diethylene glycol monoethyl ether, and butyl pyrrolidone.

4. The antimicrobial solution of claim 1, wherein the at least one solvent is present.

5. The antimicrobial solution of claim 1, wherein said alkyl sarcosines are selected from the group consisting of cocoyl sarcosine, lauroyl sarcosine, and oleoyl sarcosine, myristoyl sarcosine, and stearoyl sarcosine.

6. The antimicrobial solution of claim 1, wherein the at least one pH adjusting agent is present.

7. The antimicrobial solution of claim 1, wherein the at least one peroxygen compound is selected from the group consisting of hydrogen peroxide, dibenzyl peroxides, perboric acid, peroximonosulfuric acid, peroxydisulfuric acid, benzoyl peroxide, sodium percarbonate, potassium percarbonate, sodium peroxide, and urea peroxide.

8. The antimicrobial solution of claim 1, effective to provide a greater than about a 1-log order reduction in population of S. aureus at a contact time of up to about 5 minutes at about 20-25° C. using the using ASTM E2197-02 test method.

9. The antimicrobial solution of claim 8, wherein the pH is up to about 4.

10. A concentrated antimicrobial solution having a pH of from about 0 to about 4.5, which, when diluted with water, produces a solution according to claim 1, wherein the concentrated solution comprises, consists essentially of, or consists of:
a. at least one peroxygen compound in a concentration of from about 2 to about 20 wt. %;
b. at least one anionic surfactant selected from the group consisting of alkyl sarcosines and salts thereof having the formula (A): 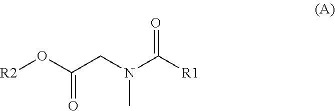
wherein R1 is a substituted or unsubstituted, saturated or unsaturated, branched or unbranched C8-24 alkyl R2 is a hydrogen or an alkaline moiety, in a concentration of from about 1 to about 40 wt. %;
c. optionally, at least one carboxylic acid in a concentration of from about 1 to about 15 wt. %;
d. optionally, up to about 50 wt. % of at least one solvent;
e. optionally, an effective amount of at least one ingredient chosen from pH adjusting agents, buffering agents, dyes, fragrances, rheology modifiers, corrosion inhibitors, peroxide stabilizing agents, hydrotropes, non-ionic surfactants, other anionic surfactants, soil suspenders or anti-redeposition agents, skin conditioning agents, and additional antimicrobial agents; and
f. the balance water;
wherein the solution is free of percarboxylic acids and precursors thereof, essential oils, bleaching agents, low molecular weight organic diamines, cationic surfactants, C₁-C₄ aldehydes, ferrous salts, parabens, enzymes, and a poly(alkylene glycol) alkyl ethers containing four or more ether linkages.

11. A dry particulate antimicrobial composition which, when dissolved in water, produces a solution according to claim 1, wherein the composition comprises, consists essentially of, or consists of:
a. an effective amount of at least one peroxygen compound;
b. an effective amount of at least one anionic surfactant selected from the group consisting of alkyl sarcosines and salts thereof having the formula (A): 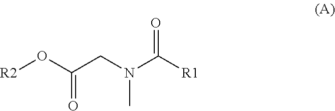
wherein R1 is a substituted or unsubstituted, saturated or unsaturated, branched or unbranched C8-24 alkyl, R2 is a hydrogen or an alkaline moiety;
c. optionally, an effective amount of at least one ingredient chosen from carboxylic acids, pH adjusting agents, buffering agents, dyes, fragrances, rheology modifiers, corrosion inhibitors, peroxide stabilizing agents, hydrotropes, non-ionic surfactants, other anionic surfactants, soil suspenders or anti-redeposition agents, skin conditioning agents, and additional antimicrobial agents;
wherein the composition is free of percarboxylic acids and precursors thereof, essential oils, bleaching agents, low molecular weight organic diamines, cationic surfactants, C₁-C₄ aldehydes, ferrous salts, parabens, enzymes, and a poly(alkylene glycol) alkyl ethers containing four or more ether linkages.

12. A method of sanitizing, disinfecting, and/or sterilizing a surface comprising applying an effective amount of the solution of claim 1 to the surface.

13. A method of sanitizing, disinfecting, and/or sterilizing a surface comprising applying an effective amount of the solution of claim 10 to the surface.
